(19) United States
(12) Patent Application Publication
(10) Pub. No.: US 2008/0133743 A1
(43) Pub. Date: Jun. 5, 2008

(54) ELECTRONIC APPARATUS AND INFORMATION PROCESSING SYSTEM

(75) Inventor: Soichi Yamamuro, Tsukubamirai-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 11/946,352

(22) Filed: Nov. 28, 2007

(30) Foreign Application Priority Data
Nov. 30, 2006 (JP) 2006-324691
Nov. 2, 2007 (JP) 2007-286687

(51) Int. Cl. G06F 15/173; G06F 3/048

(52) U.S. Cl. 709/224; 715/781

(57) ABSTRACT

To provide a technique capable of achieving more easy access form an information processing apparatus to a peripheral device while reducing the implementation load in the peripheral device, an electronic apparatus includes a storage unit which stores an operating condition information file to set an operating condition of the electronic apparatus, and a program which is executed by the external information processing apparatus and displays a user interface to refer to or change the operating condition information file, and a control unit which causes the storage unit to function as an external storage device for the information processing apparatus when the electronic apparatus is communicable with the information processing apparatus through the communication unit. The electronic apparatus operates in accordance with the contents of the operating condition information file.

### BACKGROUND OF THE INVENTION

1. Field of the Invention

The present invention relates to a technique of referring to and changing an operating condition of an electronic apparatus functioning as a peripheral device of an information processing apparatus.

2. Description of the Related Art

Conventionally, to control a peripheral device on a personal computer (PC), a user generally installs dedicated software called a “driver” unique to the peripheral device in the PC. “Installation” indicates writing dedicated software in a nonvolatile storage unit such as a hard disk drive (HDD) included in a PC so that the software can run on the PC any time. Note that the user often installs, in the PC, software downloaded from the maker's homepage through the Internet or read out from an external medium such as a CD-ROM. Japanese Patent Laid-Open No. 2006-293638 (reference 3) discloses a technique of installing software in a PC. In this prior art, software is stored in a peripheral device or a mass storage that is accessible when connected to a peripheral device, and installed when the peripheral device is connected to the PC.

A technique of controlling a peripheral device from a PC without installing dedicated software in it is also disclosed. In a technique disclosed in, e.g., Japanese Patent Laid-Open No. 2002-229752 (reference 1), a PC having a Web server function is arranged on a network. A file generated by a hypertext program installed in the server PC is prepared. The file is executed on the Web browser of the PC and controls a peripheral device through the Web server PC. To execute a hypertext program on a Web browser, the hypertext program is temporarily loaded in a volatile memory such as a RAM on the PC and executed. In this load-and-go method, the program is not installed in the PC but loaded in a volatile memory such as a RAM and executed. When the program operation finishes, the program is erased from the volatile memory. Japanese Patent Laid-Open No. 2004-005348 (reference 2) discloses a technique of directly installing a Web server function in a peripheral device. According to this technique, a user designates the IP address of a target peripheral device and accesses it by using existing Web browsing software.

However, to install and execute dedicated software in a PC, as described above, compressed software with a size of about 10 to 20 MB is decompressed (expanded) and written and saved in the PC. The installed software occupies a large memory area of the PC. The traffic volume at the time of installation is also very high. These adverse effects are becoming more conspicuous recently as the size of software increases. Especially, the former problem is serious in a thin client PC such as a portable terminal, and the latter requires, e.g., a network with a low transfer rate such as a wireless LAN to take a long time for installation. In addition, since the user can use the peripheral device only on the PC with the installed software, he/she tends to be given an impression that the device is not user-friendly.

The technique using the Web server function can mostly solve the above-described problems, though it often assumes office-oriented large peripheral devices. Hence, this technique poses the following problems regarding a small peripheral device that is directed at consumers and employs local connection as the main connection form to a PC. Even for a small peripheral device capable of network connection, for example, a user needs to check the IP address of the peripheral device and perform cumbersome operations so this method is not suitable for general users. Additionally, the technique using the Web service method is unusable for a device connected through a local I/F. Furthermore, the method of imparting a Web server function to a peripheral device imposes a heavy economic burden on a consumer peripheral device that places importance on cost reduction.

### SUMMARY OF THE INVENTION

The present invention has been made in consideration of the above-described problems, and has as its object to solve at least one of them.

According to the present invention, it is possible to provide a technique capable of solving at least one of the conventional problems in installation of dedicated software or the problems of implementation load in a peripheral device.

According to one aspect of the present invention, an electronic apparatus which functions as a peripheral device of an information processing apparatus and has a communication unit to communicate with the information processing apparatus, comprises: a storage unit which stores an operating condition information file to set an operating condition of the electronic apparatus, and a program which is executed by the information processing apparatus and displays a user interface to refer to or change the operating condition information file; and a control unit which causes the storage unit to function as an external storage device for the information processing apparatus when the electronic apparatus is communicable with the information processing apparatus through the communication unit, wherein the electronic apparatus operates in accordance with contents of the operating condition information file.

According to another aspect of the present invention, an information processing system including an information processing apparatus, and an electronic apparatus which functions as a peripheral device of the information processing apparatus and has a communication unit to communicate with the information processing apparatus, the electronic apparatus comprises: a storage unit which stores an operating condition information file to set an operating condition of the electronic apparatus, and a program which is executed by the information processing apparatus and displays a user interface to refer to or change the operating condition information file; and a control unit which causes the storage unit to function as an external storage device for the information processing apparatus when the electronic apparatus is communicable with the information processing apparatus through the communication unit, wherein the electronic apparatus operates in accordance with contents of the operating condition information file.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the internal module arrangements of an MFP and a PC according to the first embodiment;

FIG. 2 is a flowchart illustrating the operations of the MFP and PC according to the first embodiment;

FIG. 3 is a view showing a state wherein a PC 120 has mounted a mass storage memory 111;

FIGS. 4A to 4C are views showing examples of the operation window of a remote UI program 111a displayed on a display unit;

FIG. 5 is a block diagram showing the internal module arrangements of an MFP and a PC according to the modification;

FIG. 6 is a flowchart illustrating the operations of the MFP and PC according to the modification;

FIG. 7 is a view showing the schematic arrangement of a conventional dedicated driver;

FIG. 8 is a flowchart illustrating an operation of changing an MFP setting value by a remote UI program;

FIG. 9 is a flowchart illustrating a setting value acquisition operation in executing printing; and

FIG. 10 is a flowchart illustrating an MFP setting value changing operation when an information DB is used as a data port.

### DESCRIPTION OF THE EMBODIMENTS

Preferred embodiments of the present invention will be described below with reference to the accompanying drawings. Note that each element in the following embodiments is not intended to limit the scope of the invention, but is merely an example.

### First Embodiment

As an electronic apparatus according to the first embodiment of the present invention, an MFP (Multi Function Printer) will be exemplified and described below. A function of causing a PC to refer to and change various internal setting values and status information to control the MFP will be referred to as a “remote UI function” hereinafter.

<Outline>

An MFP has an area serving as an external storage device accessible from a PC connected to the MFP. The area stores a remote UI program file to be executed by the PC and a database (DB) file containing the setting values of the MFP. This configuration allows the PC to directly execute the remote UI program file stored in the area. It is therefore possible to easily refer to and change the setting values to control the MFP.

<System Arrangement>

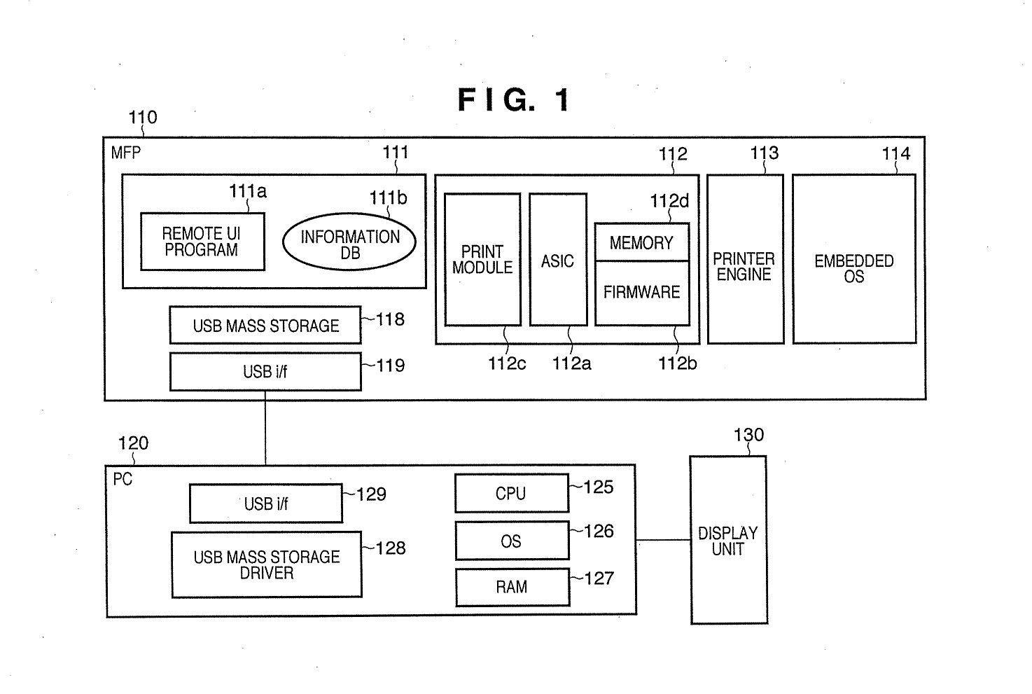

FIG. 1 is a block diagram showing the internal module arrangements of an MFP and a PC according to the first embodiment. In the first embodiment, an MFP 110 and a PC 120 are locally I/F-connected via USB I/Fs.

The MFP 110 incorporates a mass storage memory 111, control unit 112, printer engine 113, and embedded OS 114. The MFP 110 also has a USB I/F 119 to be connected to an external device such as the PC 120, and a USB mass storage 118 which provides an access function to the mass storage memory 111 through the USB I/F 119.

The mass storage memory 111 stores, as files, a remote UI program 111a and an information DB 111b. The information DB 111b stores parameters related to settings and statuses used in the MFP 110. The remote UI program 111a is a file with a format (e.g., exe format) executable by the PC 120 and has a function of referring to and changing the information DB 111b.

Firmware 112b manages the control unit 112 on the basis of various actions of local operations and various actions of remote UI operations. The control unit 112 mainly includes an ASIC 112a, the firmware 112b, a memory 112d serving as the execution space of the firmware 112b, and a print module 112c for converting print data into a format processible by the printer engine. Note that the parameters related to statuses in the above-described information DB 111b can be accessed from the control unit 112 and referred to and changed via the ASIC 112a in executing the firmware 112b. The information DB 111b may be changed to the up-to-date state upon receiving a reference instruction from the remote UI program.

The printer engine 113 is a functional unit which prints image data under the control of the control unit 112.

On the other hand, the PC 120 incorporates a USB I/F 129 to be connected to an external device such as the MFP 110, and a USB mass storage 118 to be used to access the mass storage memory 111 of the device connected through the USB I/F 129. The PC 120 also has a CPU 12S, RAM 127, and OS 126. A display unit 130 is connected to the PC 120.

<Information DB>

As described above, the information DB 111b stores parameters related to settings and statuses used in the MFP 110. The values stored in the information DB 111b are directly referred to and changed by the operation of the remote UI program 111a which is automatically loaded to the RAM 127 in the PC 120 and executed there by selection and execution from the PC 120. In addition, the statuses in the MFP 110 are referred to and changed by the control unit 112.

<Operation Sequence>

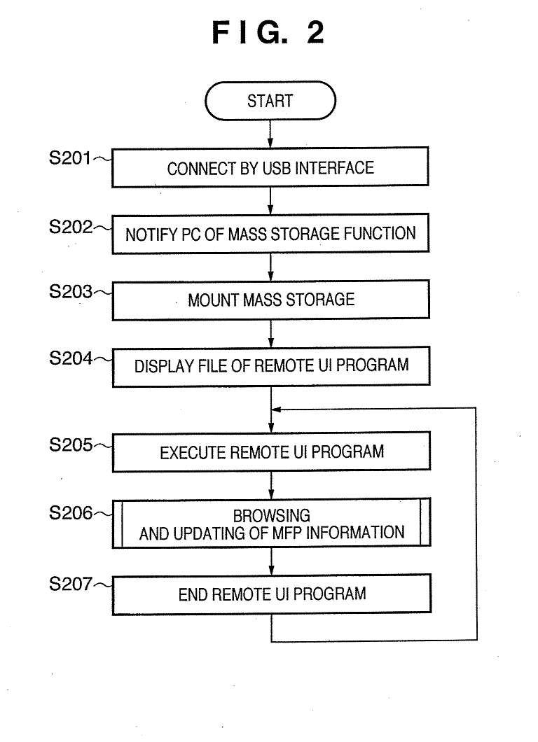

FIG. 2 is a flowchart illustrating the operations of the MFP and PC according to the first embodiment. Especially, an operation of connecting the MFP 110 and PC 120 and causing the PC 120 to refer to and change a setting value in the MFP 110 will be described.

In step S201, the MFP 110 and PC 120 are physically connected via a USB cable. That is, the USB I/Fs 119 and 129 are connected.

In step S202, the USB I/F 119 notifies the USB I/F 129 of the existence of the USB mass storage 118. That is, the PC 120 is notified that the MFP 110 has an area accessible as a USB mass storage.

In step S203, the PC 120 mounts the mass storage memory 111 as a drive via the USB mass storage driver 128. More specifically, the CPU 125 and OS 126 in the PC 120 execute this operation. In, e.g., Windows® OS available from Microsoft, a driver “USBStor.sys” is loaded. Then, the mass storage memory 111 is mounted as a new drive.

In step S204, the PC 120 makes the remote UI program 111a visible. More specifically, the PC 120 displays, on the display unit 130, the list of files in the drive mounted in step S203.

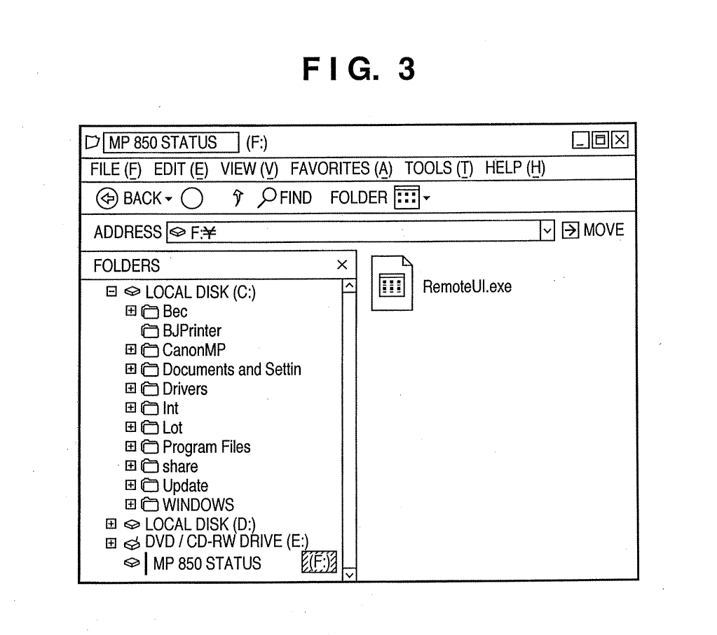

FIG. 3 is a view showing a state wherein the PC 120 has mounted the mass storage memory 111. In this example, the PC 120 mounts the mass storage memory 111 as the F drive. The F drive stores “RemoteUI.exe”, i.e., the remote UI program 111a.

In step S205, the PC 120 starts executing the remote UI program 111a. More specifically, the program starts when the PC 120 receives a user operation (e.g., double-clicking the mouse button on the “RemoteUI.exe” icon). “RemoteUI.exe” is loaded to the RAM 127 of the PC 120 and executed by the CPU 125.

In step S206, the PC 120 refers to or changes the information DB 111b on the basis of the user operation of the remote UI program 111a. This operation will be described later in detail.

In step S207, the PC 120 finishes executing the remote UI program 111a. More specifically, the program finishes when the PC 120 receives a user operation (e.g., clicking the mouse button on an “end” button). The remote UI program 111a having the exe format is automatically deleted from the RAM 127 of the PC 120 at this end.

<Details of Browsing/Updating Operation of Information DB>

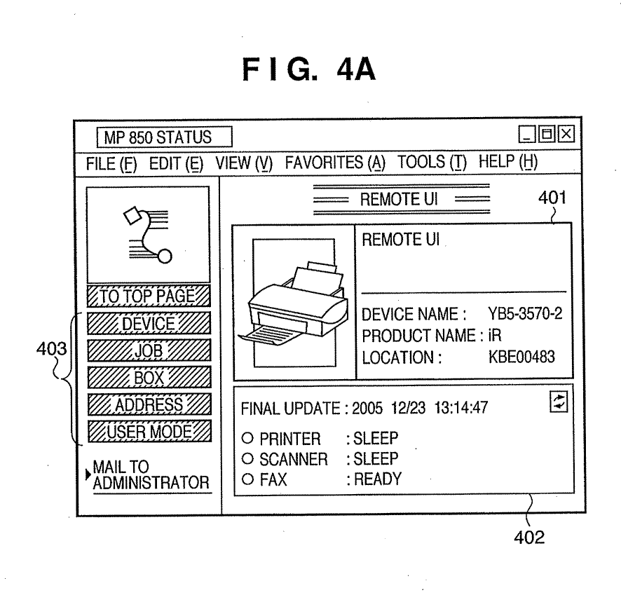

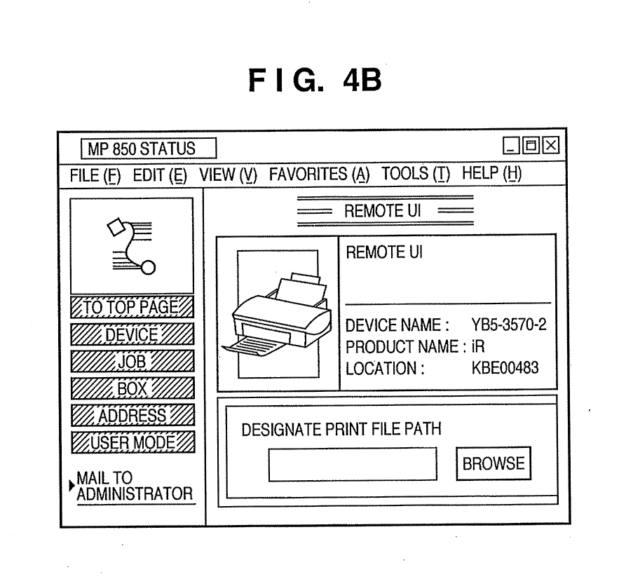

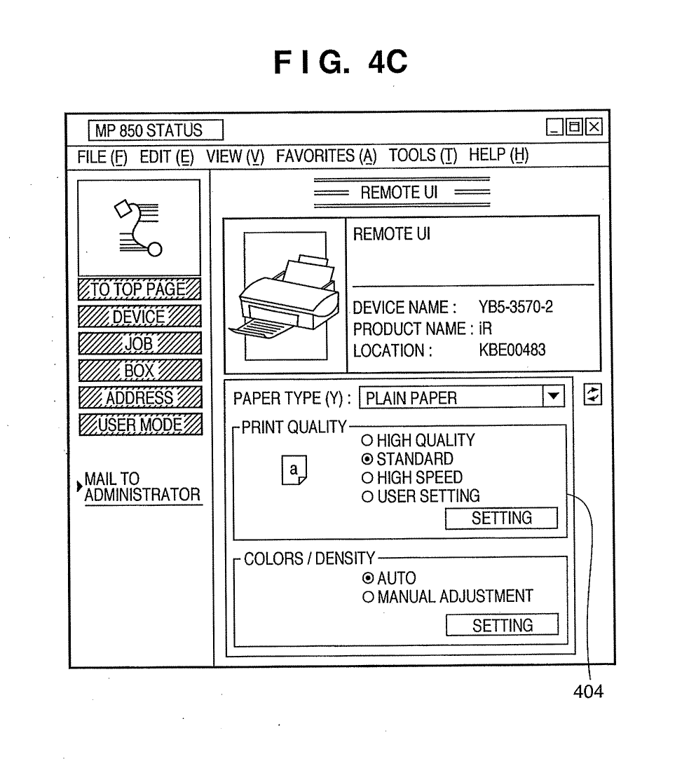

FIGS. 4A to 4C are views showing examples of the operation window of the remote UI program 111a. The display unit 130 of the PC 120 displays these windows. As described above, the remote UI program 111a is a program file that can run on the PC 120. When the remote UI program 111a is executed on the PC 120, setting information 401 and status 402 of the MFP 110 are displayed. Additionally, the user selects a button from a button group 403 and refers to and changes setting values for the selected item.

More specifically, the remote UI program 111a running on the PC 120 implements the above-described reference and change by executing read and write of the file of the information DB 111b directly from the PC 120. The file of the information DB 111b are stored in the mass storage memory 111, like the remote UI program 111a. That is, the files are stored in the drive mounted in step S203. However, the files of the information DB 111b are preferably invisible to prevent operation errors of the user.

In the above-described technique using a Web server (e.g., reference 2), the Web server in the MFP directly read- or write-accesses the information DB. In this embodiment, however, the remote UI program 111a running on the PC 120 directly read- or write-accesses the information DB. The above-described technique of reference 3 uses a mass storage function. However, a conventional dedicated driver used in this method needs to be resident in the PC by installation. In this embodiment, however, it is unnecessary to install a driver and make it resident in the PC.

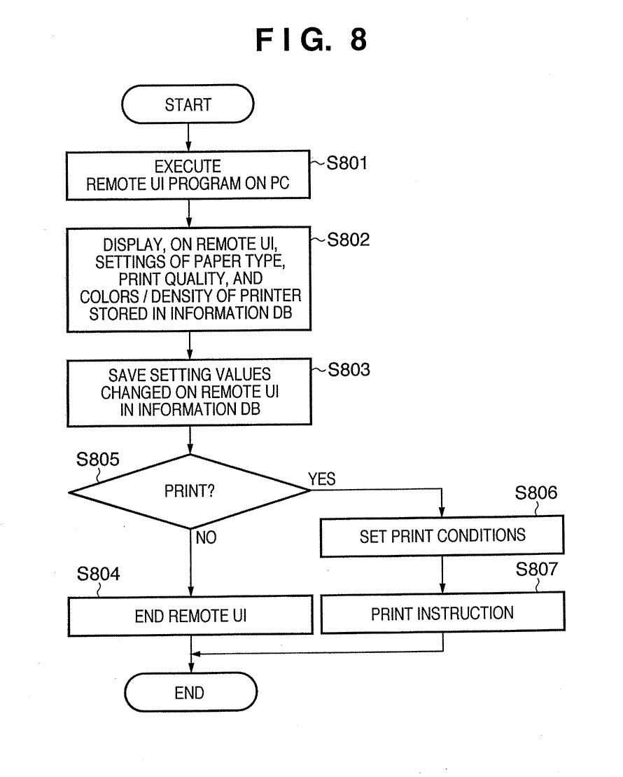

FIG. 8 is a flowchart illustrating a print operation from the remote UI program using the file of the information DB 111b.

In step S801, the PC 120 activates the remote UI program 111a. When activation finishes, the remote UI program 111a displays the operation window (UI) on the display unit 130 of the PC 120, as described above.

In step S802, print settings such as the paper type, print quality, and colors/density are received from the user through the UI (print setting dialogue box shown in FIG. 4C). In the initial state, display is done based on settings saved in the information DB 111b. The user changes the settings of items required to be changed.

In step S803, the remote UI program saves, in the information DB 111b, the setting values changed by the user. To continue the print process, the process advances to step S806. To do only settings, the process advances to step S804 to finish the remote UI program.

In step S806, designation of a file (to be referred to as print data hereinafter) to be printed is received from the user through the dialogue box shown in FIG. 4B. Upon receiving press of a “print execution button” (not shown), a print instruction and print data are saved in the information DB 111b. The process advances to step S807 to execute the print process.

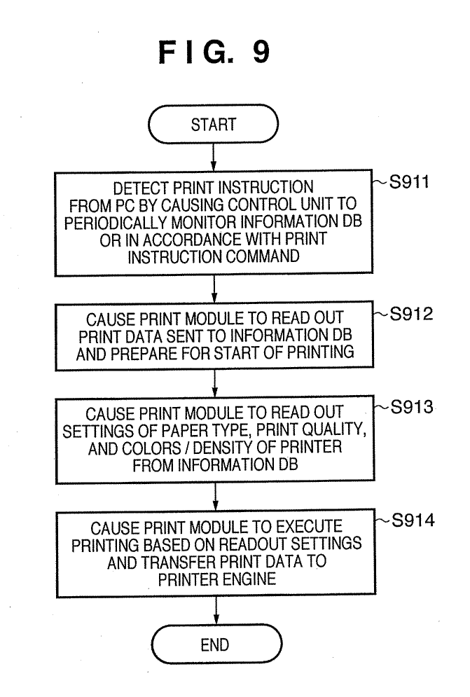

FIG. 9 is a flowchart illustrating acquisition of specific printer setting values in executing the print process.

In step S911, the print instruction that is received from the PC 120 through the remote UI program and saved in the information DB 111b is detected. Detection is done by, e.g., causing the print module 112c of the control unit 112 to periodically monitor write in the information DB 111b.

In step S912, the print module 112c of the control unit 112 starts reading out the print data from the information DB 111b.

In step S913, the print module 112c reads out, from the information DB 111b, print settings such as the paper type, print quality, and colors/density set in step S802.

In step S914, the print module 112c rasterizes the print settings and received print data into a format processible by the printer engine 113, transmits the print data to the printer engine 113, and finishes the process.

The above description has been made assuming that the information DB 111b is a file. However, the information DB 111b may be a data port to access to the memory in the control unit 112.

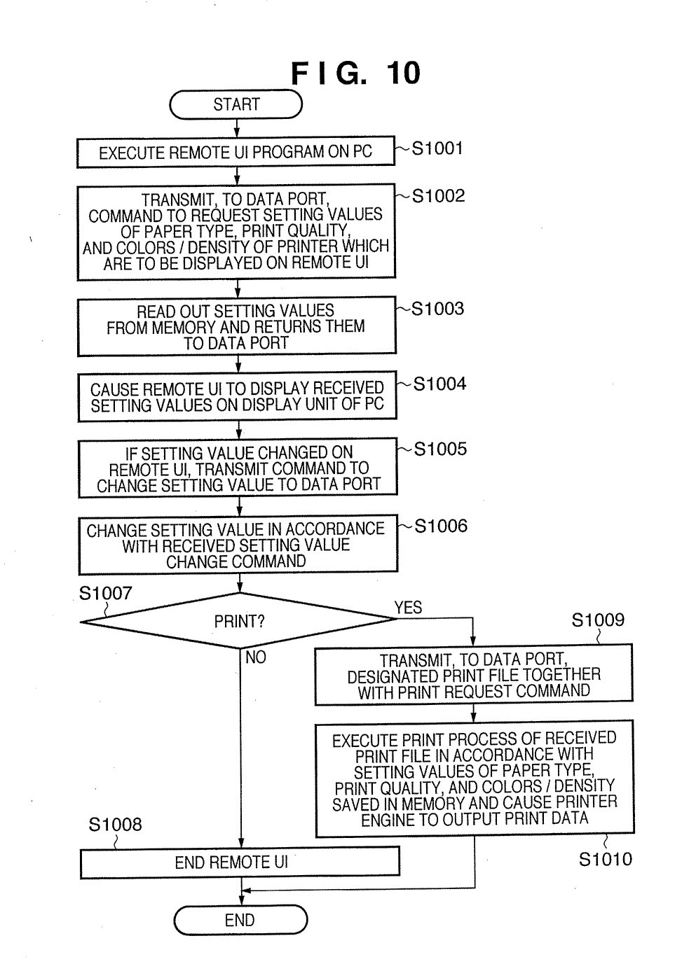

FIG. 10 is a flowchart illustrating a print operation from the remote UI program using a data port.

In step S1001, the PC 120 activates the remote UI program 111a.

In step S1002, the remote UI program 111a transmits, to the data port (information DB 111b), a command to request the current setting values of the paper type, print quality, and colors/density of the printer which are to be displayed on the remote UI.

In step S1003, upon receiving the setting value request command, the control unit 112 of the MFP 110 reads out the requested setting values from the memory 112d and returns them to the data port (information DB 111b) as a response.

In step S1004, the remote UI program 111a displays the received setting values on the display unit 130, as shown in FIG. 4C.

In step S1005, if a setting value change is received from the user through the UI (print setting dialogue box shown in FIG. 4C), the remote UI program transmits, to the data port 111b, a command to change the setting value.

In step S1006, the control unit 112 changes the setting value in the memory 112d in accordance with the received setting value change command. To continue the print process, the process advances to step S1009. To do only settings, the process advances to step S1008 to finish the remote UI program.

In step S1009, print data designation is received from the user through the dialogue box shown in FIG. 4B. Upon receiving press of a “print execution button” (not shown), a print request command and print data are transmitted to the data port 111b.

In step S1010, upon receiving the print request command, the print module 112c prints the simultaneously received print data in accordance with the setting values of the paper type, print quality, and colors/density saved in the memory 112d.

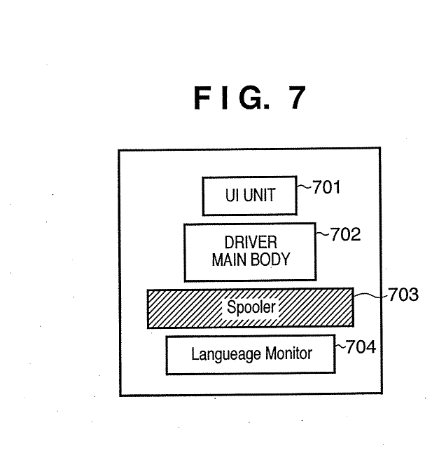

FIG. 7 is a view showing the constituent elements of a conventional printer-dedicated driver. The conventional printer-dedicated driver includes a UI unit 701, driver main body 702, spooler 703, and language monitor 704 as constituent elements. All the constituent elements must be installed in the PC 120 and executed on the RAM 127. In Windows® OS, the spooler 703 is provided as a constituent element of the OS.

In this embodiment, the remote UI program 111a corresponds to the function of the conventional UI unit 701. The print module 112c corresponds to the functions of the driver main body 702 and language monitor 704. That is, as compared to the conventional system which sends all the above-described constituent elements (e.g., 10 to 20 MBytes) to the PC 120, it is necessary to activate only the remote UI program 111a with a very small data size on the PC 120. It is therefore possible to reduce the size of the area used on the PC 120 to about several Mbytes.

As described above, a peripheral device (MFP) has an area serving as an external storage device accessible from a PC. The area stores a remote UI program file directly executable from the connected PC. The area serving as an accessible external storage device also stores a database (DB) file containing setting values control the MFP. This arrangement allows to directly refer to or change the setting values in the DB file through the remote UI program. This makes it possible to provide a technique capable of realizing more easy access to the peripheral device while reducing the internal implementation load.

(Modification)

### <Outline>

The functional arrangement is almost the same as in FIG. 1 except that the mass storage memory is formed by a network sharing function.

<System Arrangement>

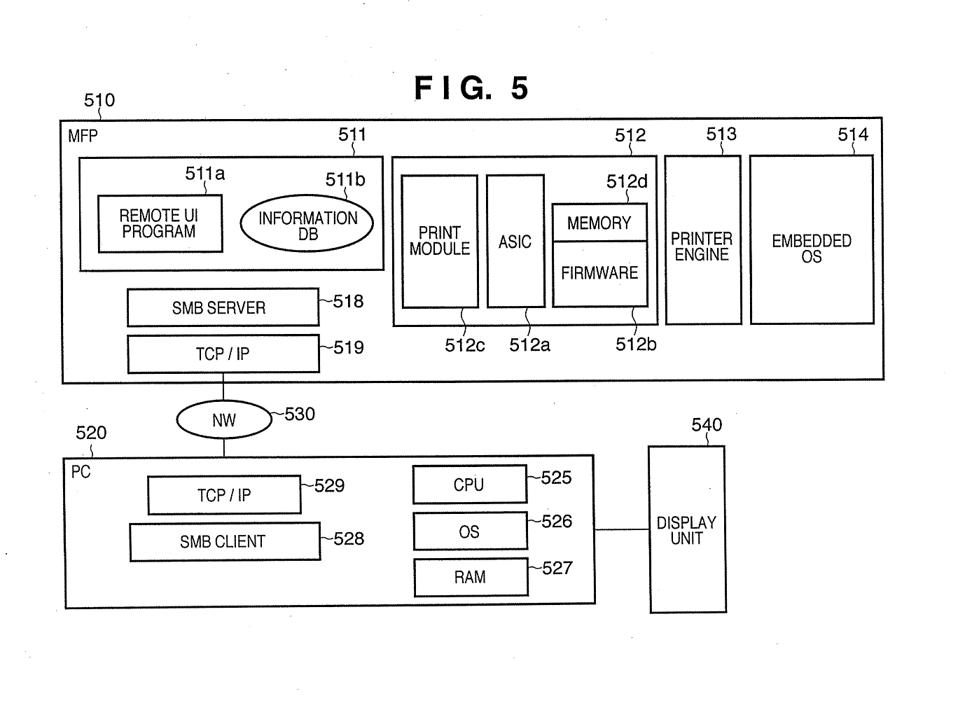

FIG. 5 is a block diagram showing the internal module arrangements of an MFP and a PC according to the modification. In this modification, an MFP 510 and a PC 520 are network-connected via a TCP/IP network (NW) 530. Only parts different from FIG. 1 will be described below.

Reference numerals 519 and 529 denote TCP/IP stacks in the MFP 510 and PC 520. Reference numerals 518 and 528 respectively denote a server which provides a file sharing function based on the SMB protocol, and a client. That is, the MFP 510 provides a mass storage memory 511 to the device connected to the NW 530 as a shared drive (or shared folder).

The PC 520 has a function of causing the SMB client 528 to search for and connect the shared drive on the NW 530. That is, the PC 520 can search for the MFP 510 without necessity of IP address designation.

<Operation Sequence>

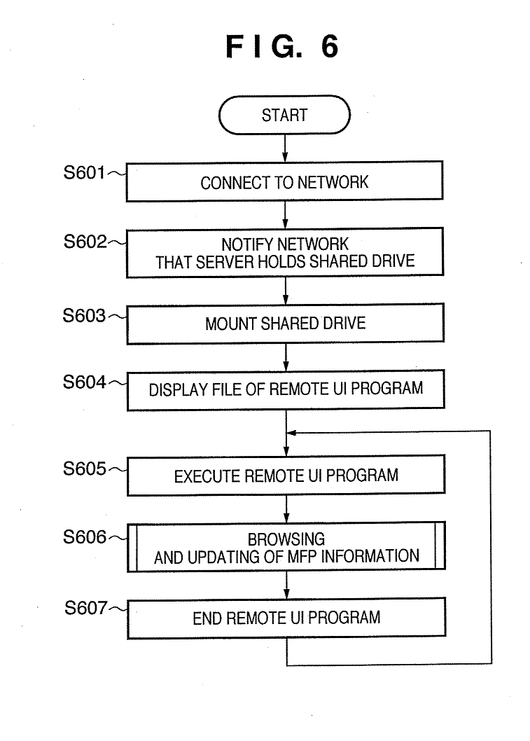

FIG. 6 is a flowchart illustrating the operations of the MFP and PC according to this modification.

Especially, an operation of connecting the MFP 510 and PC 520 and causing the PC 520 to refer to and change a setting value in the MFP 510 will be described.

In step S601, the MFP 510 and PC 520 are connected to the NW 530. That is, each of the MFP 510 and PC 520 is connected to be communicable with another terminal connected to the NW 530 by TCP/IP.

In step S602, the SMB server 518 announces the NW 530 that the server has the mass storage memory 511 serving as a shared drive based on the SMB protocol.

In step S603, the PC 520 mounts the mass storage memory 511 as a drive via the SMB client 528. More specifically, a CPU 525 and OS 526 in the PC 520 execute this operation. That is, the mass storage memory 511 is mounted as a new drive on the basis of reception of the announcement in step S602.

In step S604, the PC 520 makes a remote UI program 511a visible. More specifically, the PC 520 displays, on a display unit 540, the list of files in the drive mounted in step S603.

In step S605, the PC 520 starts executing the remote UI program 511a. More specifically, the program starts when the PC 520 receives a user operation (e.g., double-clicking the mouse button on the “RemoteUI.exe” icon). “RemoteUI.exe” is loaded to a RAM 527 of the PC 520 and executed by the CPU 525.

In step S606, the PC 520 refers to or changes information DB 511b on the basis of the user operation of the remote UI program 511a. This operation will be described later in detail.

In step S607, the PC 520 finishes executing the remote UI program 511a. More specifically, the program finishes when the PC 520 receives a user operation (e.g., clicking the mouse button on an “end” button).

As described above, the MFP having the arrangement of the modification allows to provide a technique capable of achieving more easy access to the peripheral device while reducing the internal implementation load of the peripheral device (MFP), as in the first embodiment.

### Other Embodiments

The embodiment of the present invention has been described above. The present invention is also applicable to a system including a plurality of devices or an apparatus including a single device. The type of local I/F is not limited to the USB I/F. Any other interface having a mass storage function can execute the same operation as described above and is incorporated in the technical scope of the present invention.

The present invention is also achieved by supplying a program to implement the functions of the above-described embodiment to the system or apparatus directly or from a remote site and causing the system or apparatus to read out and execute the supplied program codes. Hence, the program codes themselves which are installed in the computer to implement the functional process of the present invention are also incorporated in the technical scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-324691 filed Nov. 30, 2006 and No. 2007-286687 filed Nov. 2, 2007, which are hereby incorporated by reference herein in their entirety.

What is claimed is:

1. An electronic apparatus which functions as a peripheral device of an information processing apparatus and has a communication unit to communicate with the information processing apparatus, comprising:
a storage unit which stores an operating condition information file to set an operating condition of the electronic apparatus, and a program which is executed by the information processing apparatus and displays a user interface to refer to or change the operating condition information file; and
a control unit which causes said storage unit to function as an external storage device for the information processing apparatus when the electronic apparatus is communicable with the information processing apparatus through the communication unit,
wherein the electronic apparatus operates in accordance with contents of the operating condition information file.

2. The apparatus according to claim 1, wherein
the communication unit is an interface unit for local interface connection, and
said control unit causes said storage unit to function, for the information processing apparatus, as an external storage device based on a mass storage standard in the local interface connection.

3. The apparatus according to claim 1, wherein
the communication unit is an interface unit for network connection, and
said control unit causes said storage unit to function, for the information processing apparatus, as an external storage device based on a file sharing protocol.

4. The apparatus according to claim 1, wherein a hidden attribute is set for at least the operating condition information file, where the attribute is a function of a file system used in said storage unit.

5. The apparatus according to claim 1, further comprising a changing unit which changes the operating condition information file on the basis of a status of the electronic apparatus.

6. An information processing system including an information processing apparatus, and an electronic apparatus which functions as a peripheral device of the information processing apparatus and has a communication unit to communicate with the information processing apparatus,
the electronic apparatus comprising:
a storage unit which stores an operating condition information file to set an operating condition of the electronic apparatus, and a program which is executed by the information processing apparatus and displays a user interface to refer to or change the operating condition information file; and
control unit which causes said storage unit to function as an external storage device for the information processing apparatus when the electronic apparatus is communicable with the information processing apparatus through the communication unit,
wherein the electronic apparatus operates in accordance with contents of the operating condition information file.
